(19) United States
(12) Patent Application Publication
(10) Pub. No.: US 2026/0359491 A1
(43) Pub. Date: Nov. 12, 2026

(54) IMAGE PROCESSING APPARATUS, METHOD FOR CONTROLLING IMAGE PROCESSING APPARATUS, IMAGE PROCESSING SYSTEM, AND NON-TRANSITORY COMPUTER READABLE MEDIUM

(71) Applicant: CANON KABUSHIKI KAISHA, Tokyo (JP)

(72) Inventor: Yoshiharu ITO, Kanagawa (JP)

(21) Appl. No.: 19/665,067

(22) Filed: May 1, 2026

(30) Foreign Application Priority Data
May 12, 2025 (JP) 2025-079879

(51) Int. Cl. G06F 21/64; G06F 21/60; G06F 21/62

(52) U.S. Cl. CPC G06F 21/64; G06F 21/602; G06F 21/6209

(57) ABSTRACT

An image processing apparatus executes key pair generation processing of generating a first key pair including a first signature key and a first verification key, key acquisition processing of acquiring the first verification key, to which a signature has been assigned, by using a second signature key of a second key pair including the second signature key and a second verification key, data acquisition processing of acquiring image data, to which the signature has been assigned, and the second verification key, verification processing of performing signature verification on the signature assigned to the first verification key and the signature assigned to the image data by using the second verification key, and control processing of controlling the image data to be editable when the signature verification is successful.

### BACKGROUND

### FIELD OF THE TECHNOLOGY

The present disclosure relates to an image processing apparatus, a method for controlling an image processing apparatus, an image processing system, and a non-transitory computer readable medium.

### DESCRIPTION OF THE RELATED ART

Generally, electronic signature technology has been widely used for proving the authenticity of content that uses image data, such as still images and moving images. This electronic signature technology is a combination of a verification key cryptographic technology and a cryptographic hash technology. Furthermore, with the spread of so-called fake content and the development of technologies for automatically generating content, the need for technologies for proving the authenticity of image data is increasing. Therefore, as indicated in “The Coalition for Content Provenance and Authenticity (C2PA) Specifications (https://c2pa.org/specifications/specifications/2.0/index.html),” there is a tendency to accelerate, through standardization, the proliferation of technologies related to authenticating the source and history of content.

However, with the above-described technology, information necessary for proving authenticity can be assigned after image data has been edited or altered, but the authenticity of the image data cannot be assured prior to editing or alteration. For this reason, there is a concern that image data may be repeatedly edited and altered in a malicious manner and that such image data may be distributed.

### SUMMARY

The present disclosure provides a technology for more reliably assuring the authenticity of image data acquired by an image processing apparatus.

According to some embodiments, an image processing apparatus includes a processor, and a memory storing a program which, when executed by the processor, causes the image processing apparatus to execute key pair generation processing of generating a first key pair including a first signature key and a first verification key, key acquisition processing of acquiring the first verification key, to which a signature has been assigned, by using a second signature key of a second key pair including the second signature key and a second verification key, data acquisition processing of acquiring image data, to which the signature has been assigned, and the second verification key, verification processing of performing signature verification on the signature assigned to the first verification key and the signature assigned to the image data by using the second verification key, and control processing of controlling the image data to be editable when the signature verification is successful.

According to some embodiments, an image processing system including a generation apparatus that generates image data and an editing apparatus that edits the image data. The editing apparatus includes a processor, and a memory storing a program which, when executed by the processor, causes the editing apparatus to execute key pair generation processing of generating a first key pair including a first signature key and a first verification key, key acquisition processing of acquiring from the generation apparatus the first verification key, to which a signature has been assigned, by using a second signature key of a second key pair including the second signature key and a second verification key, data acquisition processing of acquiring from the generation apparatus the image data, to which the signature has been assigned, and the second verification key, verification processing of performing signature verification on the signature assigned to the first verification key and the signature assigned to the image data by using the second verification key, and control processing of controlling the image data to be editable when the signature verification is successful.

According to some embodiments, a method for controlling an image processing apparatus includes generating a first key pair including a first signature key and a first verification key, acquiring the first verification key, to which a signature has been assigned, by using a second signature key of a second key pair including the second signature key and a second verification key, acquiring image data, to which the signature has been assigned, and the second verification key, performing signature verification on the signature assigned to the first verification key and the signature assigned to the image data by using the second verification key, and controlling the image data to be editable when the signature verification is successful.

Features of the present disclosure will become apparent from the following description of embodiments with reference to the attached drawings. The following description of embodiments is described by way of example.

### BRIEF DESCRIPTION OF THE DRAWINGS

FIG. 1A is a diagram schematically illustrating an example of the configuration of an image processing system according to a first embodiment, and FIG. 1B is a diagram illustrating an example of the hardware configuration of the image processing apparatus according to the first embodiment.

FIG. 2 is a diagram illustrating an example of the functional configuration of the image processing apparatus according to the first embodiment.

FIG. 3A is a diagram illustrating an example of the system configuration of an image processing system according to the first embodiment, and FIG. 3B is a diagram illustrating an example of the configuration of content data according to the first embodiment.

FIG. 4 is a flowchart of processing performed by the image processing apparatus according to the first embodiment.

FIG. 5 is another flowchart of processing performed by the image processing apparatus according to the first embodiment.

### DESCRIPTION OF THE EMBODIMENTS

Hereinafter, embodiments will be described in detail with reference to the accompanying drawings. Note that the following embodiments are not intended to limit the scope of the claims. Although a plurality of features are described in the embodiments, each of these features is not necessarily essential to implementation, and the features may be combined arbitrarily. In addition, in the accompanying drawings, identical or similar components are denoted by the same reference numerals, and redundant descriptions are omitted.

### First Embodiment

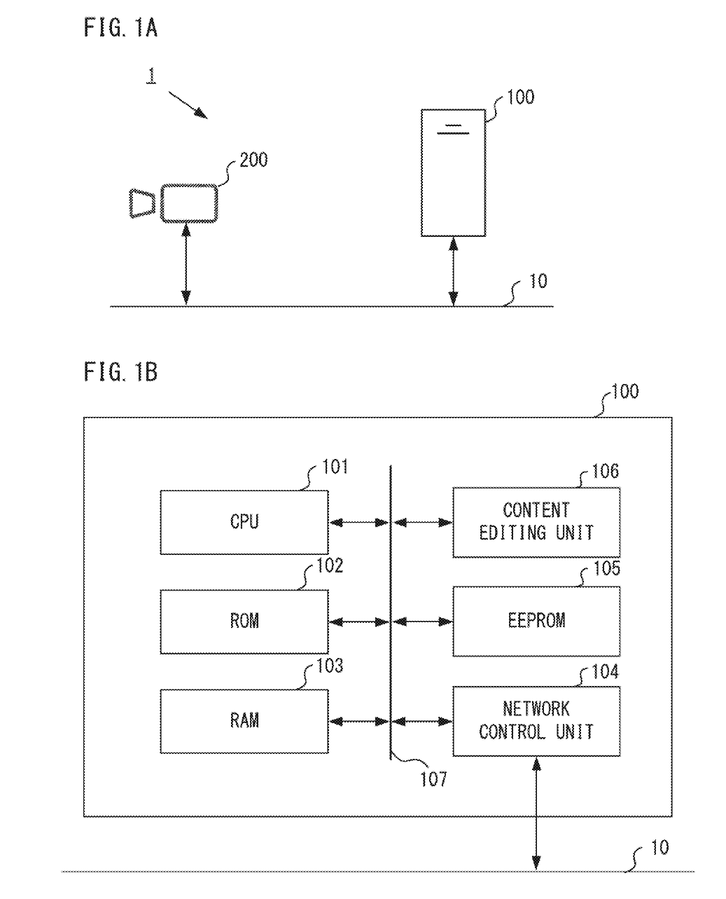

Hereinafter, an image processing system according to a first embodiment will be described. FIG. 1A is a diagram schematically illustrating a configuration of an image processing system 1 according to this embodiment. As illustrated in FIG. 1A, the image processing system 1 includes a content editing apparatus 100, which is an example of an image processing apparatus, and a network camera 200, which is an example of an image generation apparatus.

The network camera 200 is a camera having a network connection function and performs imaging processing, noise elimination processing, color space conversion processing, and the like. The network camera 200 then transmits content data including image data obtained as a result of the processing to the content editing apparatus 100 via a network 10.

Furthermore, the content editing apparatus 100 receives content data from the network camera 200 and performs various editing processing on image data included in the received content data. The content editing apparatus 100 then transmits the edited content data to an external apparatus, such as an image reproduction apparatus (not illustrated).

FIG. 1B is a block diagram illustrating a schematic configuration of the content editing apparatus 100 according to this embodiment. As illustrated in FIG. 1B, the content editing apparatus 100 includes a central processing unit (CPU) 101, a read-only memory (ROM) 102, and a random access memory (RAM) 103. Furthermore, the content editing apparatus 100 includes a network control unit 104 and an electrically erasable programmable read-only memory (EEPROM) 105. Furthermore, the content editing apparatus 100 includes a content editing unit 106. The respective components of the content editing apparatus 100 are connected to each other via a bus 107.

The CPU 101 executes a software program to control the content editing apparatus 100, thereby realizing the processing performed by the content editing apparatus 100 in this embodiment. The ROM 102 stores programs to be executed by the CPU 101. In general, an electrically rewritable read-only memory (flash memory) is used as the ROM 102. The RAM 103 temporarily stores programs and data when the CPU 101 controls the content editing apparatus 100.

The network control unit 104 controls transmission and reception of data to and from opposing devices (not illustrated) on the network 10. The EEPROM 105 is a non-volatile memory that stores data generated by the CPU 101 during execution of a program and retains the stored data even when the power supply of the content editing apparatus 100 is turned off.

The content editing unit 106 performs editing of image data. In this embodiment, the content editing unit 106 is assumed to be hardware having an editing function, such as sharpness adjustment on image data acquired from the network camera 200. However, the function of the content editing unit 106 may alternatively be implemented in software through execution of a program by the CPU 101 without using hardware. Furthermore, the editing processing performed by the content editing unit 106 may include editing processing other than the sharpness adjustment.

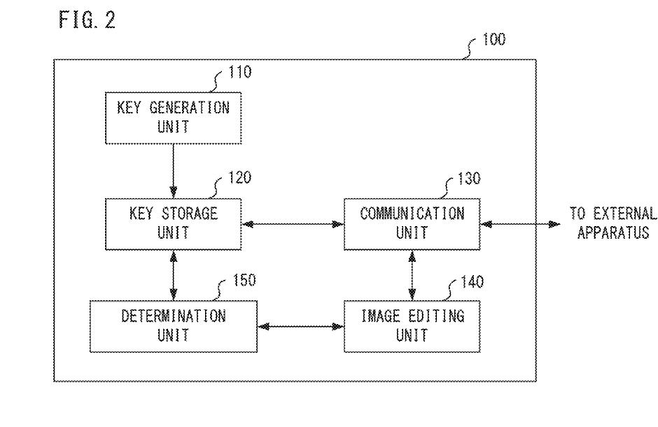

FIG. 2 is a diagram illustrating an example of function blocks of the content editing apparatus 100 according to this embodiment. As illustrated in FIG. 2, the content editing apparatus 100 includes a key generation unit 110, a key storage unit 120, a communication unit 130, an image editing unit 140, and a determination unit 150.

The key generation unit 110 is key pair generation means for generating a key pair including a signature key (private key) and a verification key (public key) intrinsic to the content editing apparatus 100 in accordance with a known public key cryptographic scheme. The key storage unit 120 stores a key pair generated by the key generation unit 110. Furthermore, the key storage unit 120 outputs key information of the stored key pair to the communication unit 130 and stores key information received from the communication unit 130.

The communication unit 130 receives content data from the network camera 200, and also transmits content data including image data edited by the image editing unit 140 to an external apparatus such as an image reproduction apparatus (not illustrated). Furthermore, the communication unit 130 is key acquisition means for acquiring key information used in the processing of this embodiment, which will be described later, and is data acquisition means for acquiring image data. The communication unit 130 transmits a verification key output from the key storage unit 120 to the network camera 200. As a result, the content editing apparatus 100 requests the network camera 200 to issue an electronic signature with respect to the verification key that is stored in the key storage unit 120 and retained by the content editing apparatus 100 itself. Furthermore, the communication unit 130 receives, from the network camera 200, a verification key for which an electronic signature has been completed and transmits the received verification key to the key storage unit 120.

In this embodiment, processing for requesting an electronic signature with respect to a verification key and processing for acquiring the verification key for which the electronic signature has been completed are realized by processing relating to a certificate signing request (CSR), which is known in network communication.

The image editing unit 140 performs editing processing on image data received from the communication unit 130 and outputs the edited image data to the communication unit 130.

The determination unit 150 is verification means for performing signature verification on image data. The determination unit 150 determines whether the image data received from the image editing unit 140 is editable and notifies the image editing unit 140 of the determination result. The image editing unit 140 is control means for controlling, on the basis of the determination result notified from the determination unit 150, the image data to be editable when the image data is editable, and performs editing processing on the image data. In this embodiment, in the determination processing as to whether the image data is editable, the determination unit 150 uses a verification key stored in the key storage unit 120 for which an electronic signature has been completed by the network camera 200. Note that details of the determination processing by the determination unit 150 will be described later.

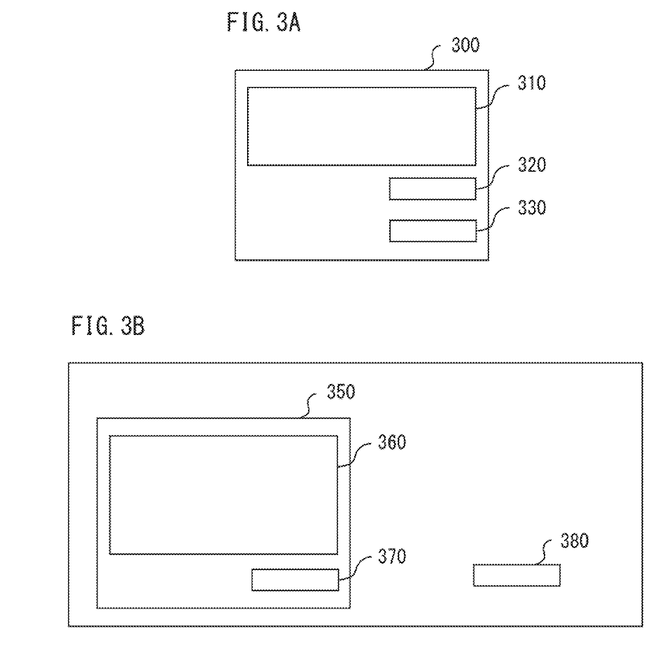

FIGS. 3A and 3B are diagrams schematically illustrating an example of the configuration of content data according to this embodiment. As illustrated in FIG. 3A, content data 300 is divided into image data 310, electronic signature data 320, and verification key data 330.

The image data 310 is data indicating an image captured by the network camera 200. The electronic signature data 320 is data of an electronic signature assigned to the image data 310 by the network camera 200 using a signature key. Note that the signature key used to assign the electronic signature to the image data 310 is generated within the network camera 200. Furthermore, since an electronic signature technology for assigning an electronic signature to the image data 310 is a known technology, a detailed description thereof will be omitted. Furthermore, a case in which the image data is encoded is also assumed. In this case as well, since the electronic signature technology for assigning an electronic signature to the image data is a known technology, a detailed description thereof will be omitted. The verification key data 330 is data of a verification key corresponding to the signature key used to generate the electronic signature included in the electronic signature data 320.

In an example illustrated in FIG. 3A, the image data 310, the electronic signature data 320, and the verification key data 330 are combined into single content data 300. In this case, the network camera 200 transmits the content data 300 to the content editing apparatus 100. As a result, the image data, the electronic signature data, and the verification key data are collectively transmitted from the network camera 200 to the content editing apparatus 100.

However, the configuration of the content data 300 in this embodiment is not limited to this, and for example, a configuration illustrated in FIG. 3B may be employed. In the example illustrated in FIG. 3B, content data 350 includes image data 360 and electronic signature data 370. Furthermore, verification key data 380 is separated from the content data 350. As a result, the content data 350 and the verification key data 380 are asynchronously transmitted from the network camera 200 to the content editing apparatus 100. Furthermore, the verification key data 380 may be transmitted to the content editing apparatus 100 via, for example, an external apparatus (not illustrated) for managing a verification key, instead of being directly transmitted from the network camera 200 to the content editing apparatus 100.

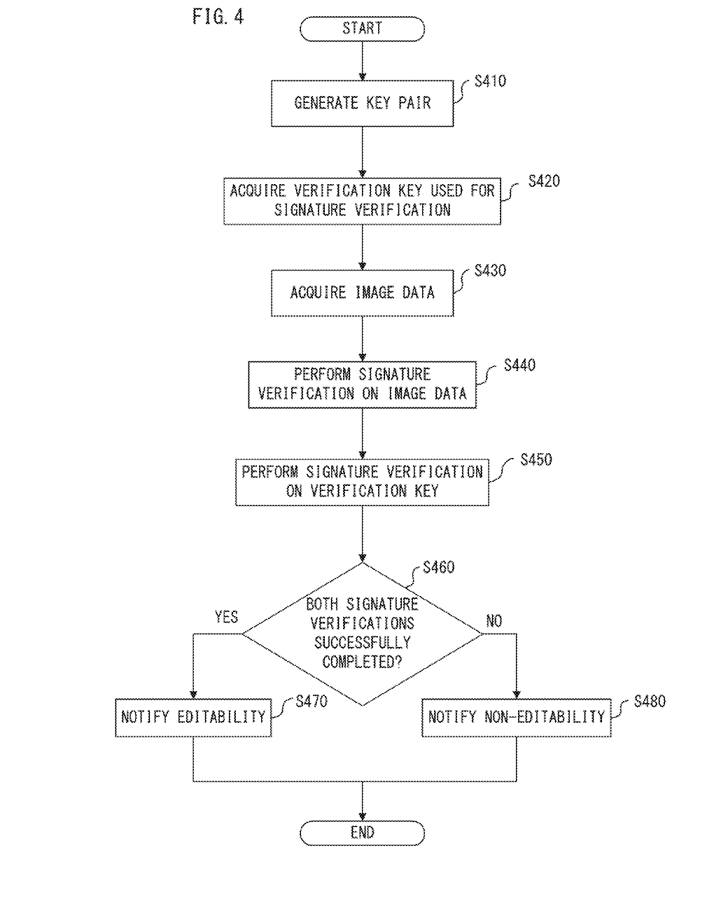

FIG. 4 is a flowchart illustrating an example of processing performed by the CPU 101 of the content editing apparatus 100 according to this embodiment. Furthermore, as an example, a program for performing the processing described below is stored in the ROM 102, and the CPU 101 reads the program from the ROM 102 and executes the program. Alternatively, the CPU 101 may transfer the program from the ROM 102 to the RAM 103 in advance and then read and execute the program from the RAM 103 to perform the following processing.

In step S410, the CPU 101 generates a key pair including a signature key and a verification key using the key generation unit 110. The signature key and the verification key generated by the key generation unit 110 in this step are a first signature key and a first verification key, respectively. Furthermore, the key pair including the first signature key and the first verification key may be regarded as a key pair intrinsic to the content editing apparatus 100. The CPU 101 stores the generated key pair in the key storage unit 120. Upon completing the processing of this step, the CPU 101 proceeds to step S420.

In step S420, the CPU 101 acquires the verification key generated in step S410 from the key storage unit 120, and transmits the acquired verification key to the network camera 200 by controlling the communication unit 130. Furthermore, the CPU 101 requests the network camera 200 to assign an electronic signature to the verification key transmitted to the network camera 200 by controlling the communication unit 130.

In this embodiment, the network camera 200 is assumed to generate and retain a key pair including a signature key and a verification key in advance before this flowchart starts. Note that the signature key and the verification key retained by the network camera 200 are a second signature key and a second verification key, respectively. Furthermore, the key pair including the second signature key and the second verification key may be regarded as a key pair intrinsic to the network camera 200. The network camera 200 receives the verification key and the request for an electronic signature from the content editing apparatus 100, and assigns the electronic signature to the received verification key using the retained signature key. The network camera 200 transmits the verification key to which the electronic signature has been assigned to the content editing apparatus 100. The CPU 101 receives the verification key to which the electronic signature has been assigned from the network camera 200 by controlling the communication unit 130, and stores the received verification key in the key storage unit 120. Next, the CPU 101 proceeds to step S430.

In step S430, the CPU 101 acquires image data from the network camera 200. Specifically, the network camera 200 generates image data 310 by imaging and assigns an electronic signature to the generated image data 310 using the retained signature key. The network camera 200 then generates content data 300 using the image data 310, electronic signature data 320 assigned to the image data 310, and verification key data 330 of the verification key corresponding to the signature key used to assign the electronic signature. The network camera 200 transmits the generated content data 300 to the content editing apparatus 100. The CPU 101 receives the content data 300 from the network camera 200 by controlling the communication unit 130, and acquires, from the received content data 300, the image data 310 and the verification key data 330 used to perform signature verification on the electronic signature data 320.

Next, in step S440, the CPU 101 performs signature verification on the image data 310 acquired in step S430. The signature verification in this step assures that the image data 310 has not been altered and that the source of the data is the network camera 200. Namely, the signature verification assures that the image data 310 was generated by the network camera 200. Furthermore, in step S450, the CPU 101 performs signature verification on the verification key acquired in step S420 to which the electronic signature has been assigned. Specifically, the signature verifications in steps S440 and S450 are realized by combining a technology for assuring data uniqueness and a public key cryptographic technology.

Here, a technology for assuring data uniqueness will be described. In this technology, a “hash” technology is employed in which data of a fixed size is always output even when data of any size is input. Data output by the hash technology is referred to as a “hash value,” a “digest value,” or the like. Furthermore, in a hash technology used for signature verification, different hash values are obtained for different input data. This technology assures that the data has not been altered, namely, data uniqueness.

Next, a public key cryptographic technology will be described. In the signature verification of this embodiment, a public key cryptographic technology is employed in which key information used for signing and key information used for verification have different characteristics. Here, the key information used for signing is also referred to as a signature key (private key), and the key information used for verification is also referred to as a verification key (public key). These keys form a key pair, and their key information does not overlap that of other key pairs. This is because key information is generally generated using random number information. Furthermore, data signed using the signature key can be successfully verified only with the verification key forming the corresponding key pair. Accordingly, data signed using different signature keys is never the same. With this technology, by keeping a signature key confidential, it is possible to identify the origin of data that can be successfully verified using a verification key.

In this embodiment, the network camera 200 calculates a hash value using image data obtained by imaging and generates an electronic signature for the image data using a signature key. Furthermore, the network camera 200 transmits, to the content editing apparatus 100, a pair including the image data to which the electronic signature has been assigned and a verification key. Then, the content editing apparatus 100 performs signature verification on the image data received from the network camera 200 and the verification key acquired in step S420, using the verification key received from the network camera 200. Specifically, the CPU 101 of the content editing apparatus 100 recalculates a hash value of the image data. When the recalculated hash value matches the hash value obtained by verifying the electronic signature using the verification key, the CPU 101 determines that the signature verification on the image data has been successfully completed. Similarly, with respect to the verification key acquired in step S420, the CPU 101 determines whether the signature verification has been successfully completed using the verification key received from the network camera 200. Note that the verification key used for the signature verification may be acquired in advance by the content editing apparatus 100.

In this embodiment, through the processing of steps S440 and S450, the content editing apparatus 100 can confirm whether the image data 310 was generated by the network camera 200 is authentic. In addition, the content editing apparatus 100 can authenticate whether the verification key acquired in step S420 is a verification key to which the electronic signature has been assigned by the network camera 200.

Next, in step S460, the CPU 101 determines whether both the signature verification on the image data in step S440 and the signature verification on the verification key in step S450 have been successfully completed, i.e., whether both of the signature verifications have been successfully completed. When it is determined that the signature verification on the image data and the signature verification on the verification key have been successfully completed, i.e., both of the signature verifications have been successfully completed (S460: YES), the CPU 101 proceeds to step S470. On the other hand, when it is determined that at least one of the signature verification on the image data and the signature verification on the verification key has not been successfully completed, i.e., one of the signature verifications has failed (S460: NO), the CPU 101 proceeds to step S480.

In step S470, the CPU 101 controls the image data 310 acquired in step S430 to be in an editable state, and notifies the image editing unit 140 that the image data 310 is editable. On the other hand, in step S480, the CPU 101 controls the image data 310 acquired in step S430 to be in a non-editable state, and notifies the image editing unit 140 that the image data 310 is non-editable. When the processing of step S470 or step S480 is completed, the CPU 101 ends the processing of this flowchart.

Through the above processing, in this embodiment, the content editing apparatus 100 can verify, before editing image data acquired from the network camera 200, both the authenticity and the origin of the image data. Furthermore, in this embodiment, image data may be determined to be non-editable, for example, when it was not generated by the network camera 200. Furthermore, image data may be determined to be non-editable, for example, when the image data generated by the network camera 200 has been unintentionally or maliciously altered by third parties. Accordingly, in the image processing system 1, editing of image data from unintended sources is suppressed, thereby reducing the possibility of such image data being leaked.

In addition, in this embodiment, the CPU 101 of the content editing apparatus 100 may assign a signature to edited image data using a signature key (first signature key) retained by the content editing apparatus 100. Then, for example, by controlling the communication unit 130, the content editing apparatus 100 transmits data, in which the image data to which the signature has been assigned and the signature key used for the signature are associated with each other, to an external apparatus.

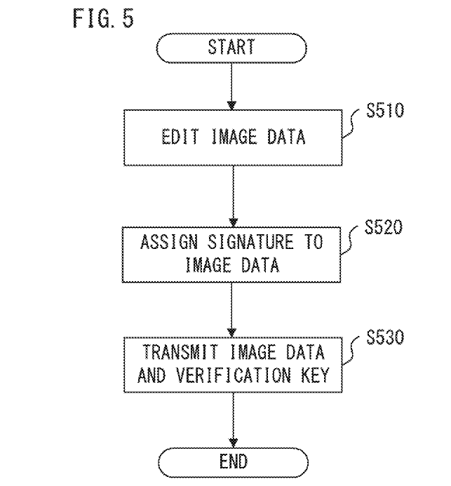

The processing performed by the CPU 101 of the content editing apparatus 100 in this case will be described with reference to the flowchart of FIG. 5. In step S510, the CPU 101 performs editing processing, such as sharpness adjustment, on the image data determined to be editable as a result of the processing illustrated in FIG. 4. Next, in step S520, acting as signature assigning means, the CPU 101 assigns a signature to the image data edited in step S510, using the signature key (first signature key) retained by the content editing apparatus 100. Then, in step S530, by controlling the communication unit 130, the CPU 101 transmits data, in which the image data to which the signature has been assigned in step S520 and the signature key used for assigning the signature are associated with each other, to an external apparatus.

As a result, an external apparatus that has received the data and acquired the image data and the signature key performs signature verification on the image data using the signature key, thereby enabling various types of processing on the image data after its authenticity has been verified. Accordingly, even after editing the image data, the content editing apparatus 100 can assure the authenticity of the image data.

According to the technology of the present disclosure, the authenticity of image data acquired by an image processing apparatus can be more reliably assured.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the technology of the present disclosure, more reliably assuring the authenticity of image data acquired by an image processing apparatus can be achieved.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-079879, filed May 12, 2025, which is hereby incorporated by reference herein in its entirety.

What is claimed is:

1. An image processing apparatus comprising:
a processor; and
a memory storing a program which, when executed by the processor, causes the image processing apparatus to execute
key pair generation processing of generating a first key pair including a first signature key and a first verification key,
key acquisition processing of acquiring the first verification key, to which a signature has been assigned, by using a second signature key of a second key pair including the second signature key and a second verification key,
data acquisition processing of acquiring image data, to which the signature has been assigned, and the second verification key,
verification processing of performing signature verification on the signature assigned to the first verification key and the signature assigned to the image data by using the second verification key, and
control processing of controlling the image data to be editable when the signature verification is successful.

2. The image processing apparatus according to claim 1, wherein
the program, when executed by the processor, further causes the image processing apparatus to execute signature assigning processing of assigning, by using the first signature key, a signature to the image data that has been edited.

3. The image processing apparatus according to claim 2, wherein
the program, when executed by the processor, further causes the image processing apparatus to execute transmission processing of transmitting data in which the image data, to which the signature has been assigned by the signature assigning processing, and the first verification key are associated with each other.

4. The image processing apparatus according to claim 1, wherein
the first key pair is a key pair intrinsic to the image processing apparatus.

5. The image processing apparatus according to claim 1, wherein
the second key pair is a key pair intrinsic to a generation apparatus that generates the image data.

6. An image processing system including a generation apparatus that generates image data and an editing apparatus that edits the image data, wherein
the editing apparatus comprises
a processor, and
a memory storing a program which, when executed by the processor, causes the editing apparatus to execute
key pair generation processing of generating a first key pair including a first signature key and a first verification key,
key acquisition processing of acquiring from the generation apparatus the first verification key, to which a signature has been assigned, by using a second signature key of a second key pair including the second signature key and a second verification key,
data acquisition processing of acquiring from the generation apparatus the image data, to which the signature has been assigned, and the second verification key,
verification processing of performing signature verification on the signature assigned to the first verification key and the signature assigned to the image data by using the second verification key, and
control processing of controlling the image data to be editable when the signature verification is successful.

7. A method for controlling an image processing apparatus, the method comprising:
generating a first key pair including a first signature key and a first verification key;
acquiring the first verification key, to which a signature has been assigned, by using a second signature key of a second key pair including the second signature key and a second verification key;
acquiring image data, to which the signature has been assigned, and the second verification key;
performing signature verification on the signature assigned to the first verification key and the signature assigned to the image data by using the second verification key; and
controlling the image data to be editable when the signature verification is successful.

8. A non-transitory computer readable medium that stores a program, wherein the program causes a computer to execute a control method of an image processing apparatus, the control method comprising:
generating a first key pair including a first signature key and a first verification key;
acquiring the first verification key, to which a signature has been assigned, by using a second signature key of a second key pair including the second signature key and a second verification key;
acquiring image data, to which the signature has been assigned, and the second verification key;
performing signature verification on the signature assigned to the first verification key and the signature assigned to the image data by using the second verification key; and
controlling the image data to be editable when the signature verification is successful.
